(19) United States
(12) Patent Application Publication
(10) Pub. No.: US 2013/0213777 A1
(43) Pub. Date: Aug. 22, 2013

(54) TAP CHANGER

(71) Applicants: Dieter Dohnal, Lappersdorf (DE); Hubert Haering, Deuerling (DE); Karlheinz Lindl, Donaustauf (DE)

(72) Inventors: Dieter Dohnal, Lappersdorf (DE); Hubert Haering, Deuerling (DE); Karlheinz Lindl, Donaustauf (DE)

(21) Appl. No.: 13/808,932

(22) PCT Filed: Jul. 7, 2011
(86) PCT No.: PCT/EP2011/003394

§ 371 Date: Feb. 12, 2013

(30) Foreign Application Priority Data
Aug. 18, 2010 (DE) 20 2010 011 524.8
Sep. 18, 2010 (DE) 20 2010 012 811.0

(51) Int. Cl. H01H 9/00

(52) U.S. Cl. CPC H01H 9/0011
USPC 200/11 TC

(57) ABSTRACT

The invention relates to a tap changer for switching among winding taps of a step transformer without interruption, said step transformer having an oil-filled transformer tank, wherein the tap changer does not have a separate housing or a housing that completely encloses the tap changer and is arranged on the outside of or inside the transformer tank connected to the oil filling of the step transformer.

The invention relates to a tap changer for uninterrupted switching over between winding taps of a tapped transformer.

Such tap changers are known in principle as built-in changers or as add-on changers.

A typical built-in changer usually consists of a load changeover switch in a separate oil vessel for the actual uninterrupted load changeover and a selector, which is arranged thereunder, for preselection of the winding tap of the tapped transformer that is to be subsequently switched over to. Such a built-in changer, hence the name, is introduced and mounted from above entirely in the oil-filled transformer vessel. In that case it is ensured by the separate oil vessel of the load changeover switch that the oil volume thereof does not intermix with the is surrounding insulating oil in the transformer vessel. It is then generally necessary to take electric lines as so-called conducting equipment from the individual winding taps into the interior of the transformer through the transformer vessel to the tap changer.

A typical add-on changer, such as is known from, for example, the company publication of Reinhausen Manufacturing Inc.: ‘VACUTAP® RMV-A On-Load Tap-Changer for Regulating Transformers’ has a separate, enclosing housing, usually of sheet metal, and is placed laterally on the outer wall of the transformer. The housing of such an add-on changer is filled with insulating oil. In this regard it is also necessary to take the electrical lines from the individual winding taps into the interior of the transformer through the entire transformer vessel and moreover additionally through a sealing, so-called transformer board, also termed barrier board, outwardly to the laterally attached tap changer. DE 29 23 170 [U.S. Pat. No. 4,234,864] describes such transformer boards, there called “terminal board”. Because the attached tap changer is accommodated in a separate oil-filled housing, it is necessary for the similarly oil-filled transformer vessel to be separated by an oil-tight partition wall, wherein the terminals for connection of the transformer taps with the tap changer are provided at the “terminal board”.

Not only the required conducting equipment, but also the transformer board are complicated and expensive.

Moreover, in the case of all the prior art it is necessary to provide a separate oil circuit for the tap changer, is which usually also includes a separate circuit breaker relay, individual pipelines as well as a separate expander and also separate air dehumidifier.

The object of the invention is to avoid the disadvantages of these known solutions and to indicate a tap changer that is of simple construction and favorable in cost.

This object is fulfilled by a tap changer with the features of the first patent claim. The subclaims relate to advantageous developments of the invention.

According to the invention a tap changer no longer has a housing that is its own or that completely surrounds it; this means that there is only a single oil vessel, namely that of the transformer, by the insulating oil of which the add-on or built-in tap changer or components thereof is or are also surrounded.

The tap changer can thus be mounted particularly advantageously at, for example, a transformer pocket or receiving pocket, i.e. a recess or a spatial region that is provided by the transformer manufacturer in the concept of the transformer vessel. Due to the fact that the tap changer no longer has a separate housing completely surrounding and sealing it and thus a separate oil volume, neither a transformer board nor, in particular, seals are any longer necessary.

According to the invention the tap changer thus does not have a separate oil vessel; it can be arranged particularly advantageously at or directly in the transformer in the oil volume thereof. Due to the fact that the tap changer no longer has a separate housing completely surrounding and sealing it and thus a separate oil volume the described additional measures are superfluous.

This solution in accordance with the invention is also suitable for hermetic solutions. The volume of the transformer vessel is greater by orders of magnitude than the previous separate oil volume of tap changers according to the prior art, so that a possible slight oil contamination by the tap changer can be tolerated. This is particularly so when the tap changer is equipped with vacuum switching cells instead of mechanical, arc-generating contacts.

It was, in fact, already known from DE 10 2008 027 274 [US 2011/0063064], by contrast to long-standing prior art, to allow intermixing of the oil volumes of transformer and tap changer, but there this related merely to a proposed common oil expansion vessel above the transformer. Thereagainst, the invention emphatically dispenses with a separate oil volume and an individual housing of the tap changer itself.

According to a first form of embodiment of the invention the tap changer is provided as an add-on changer at the transformer. Since a common oil volume is present, it is possible to dispense with the above-discussed barrier board previously necessary according to the prior art.

According to a second form of embodiment of the invention the tap changer is arranged in the interior of the transformer in the region of the interstice of the transformer windings. This has the particular advantage of only short lines from the winding taps to the respective tap changer. Moreover, the best preconditions for ideal cooling are present, since the tap changer lies directly in the main oil flow of the transformer.

According to a preferred development of the invention the tap changer is eliminated as an independent complete apparatus with completely enclosing housing; instead of that, separate, distinct components, namely the load changeover switch on the one hand and one or more selectors on the other hand, are provided. These components without an individual housing, which advantageously are designed as modules, can be arranged at different locations at or in the transformer. The complicated conducting equipment of the prior art is thereby eliminated.

In addition, it is advantageous within the scope of the invention to provide, in the case of specific forms of embodiment, the respective drive motor directly at the tap changer, i.e. to arrange it under oil. A drive linkage is thus no longer necessary and the previous coupling is eliminated.

The invention shall be explained in more detail in the following by way of drawings, in which:

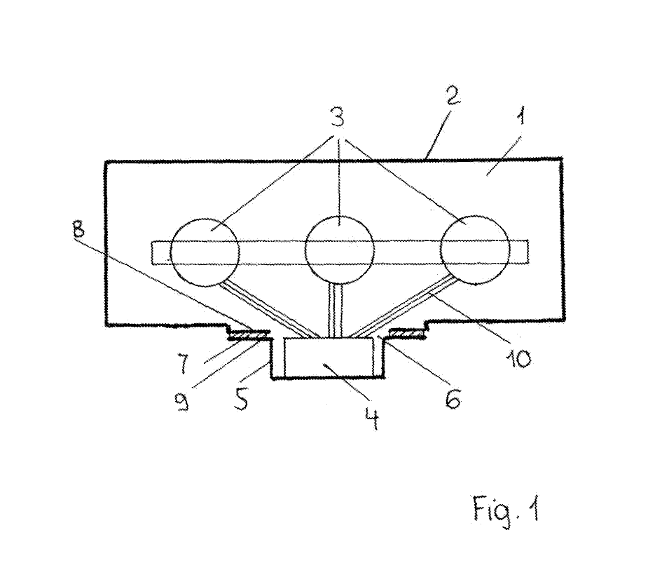

FIG. 1 shows a first form of embodiment of a tap changer according to the invention as an add-on changer,

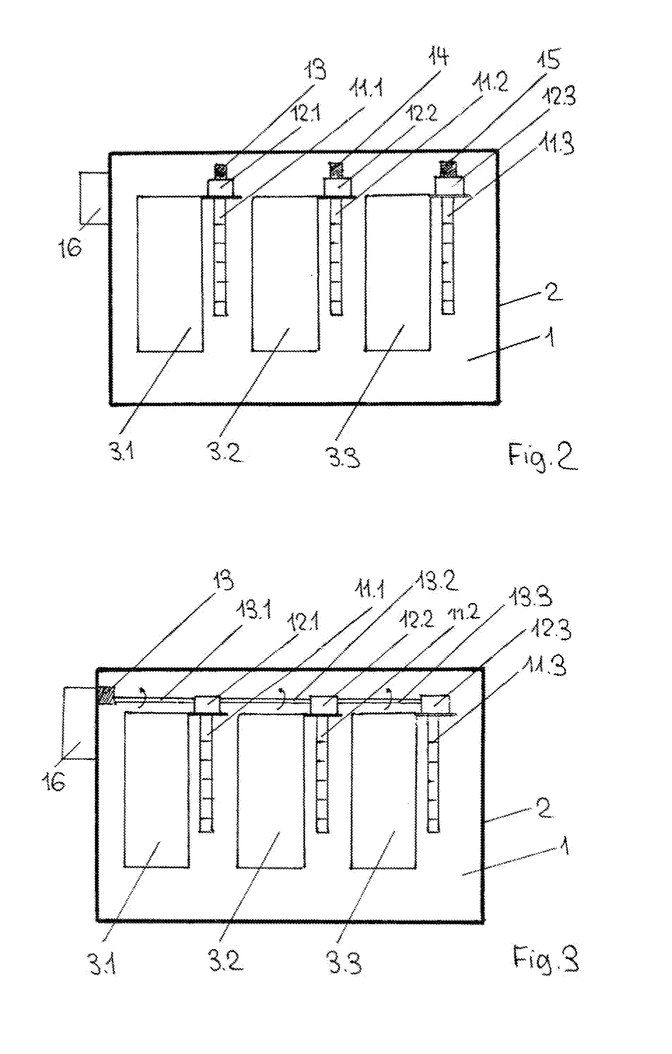

FIG. 2 shows a second form of embodiment as a built-in changer,

FIG. 3 shows a further form of embodiment as a built-in changer,

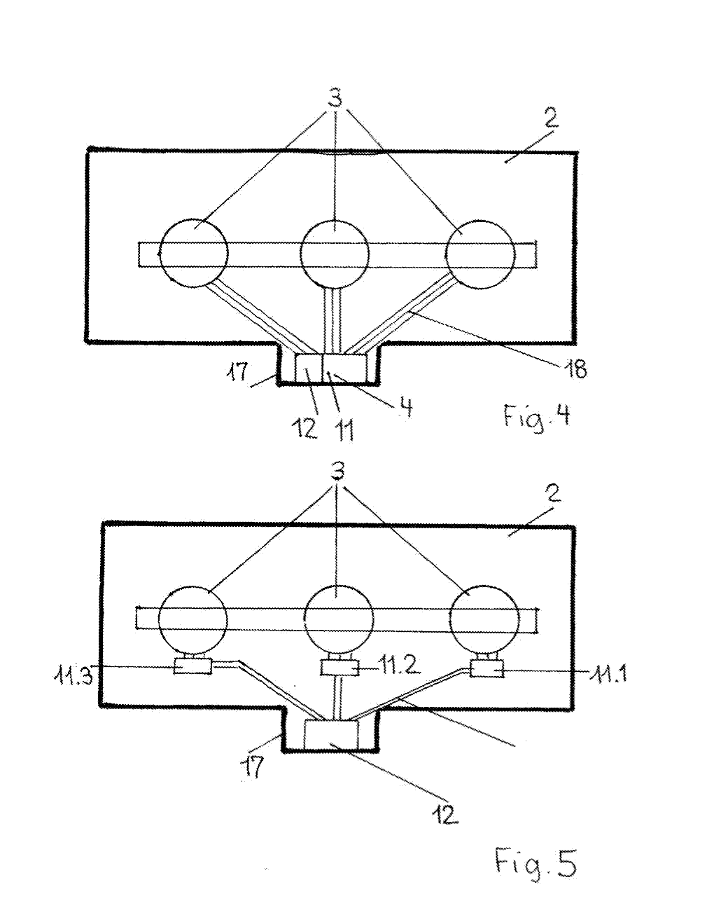

FIG. 4 shows a further form of embodiment of a tap changer arranged in a transformer vessel,

FIG. 5 shows a further form of embodiment with separate selectors as well as a common load changeover switch,

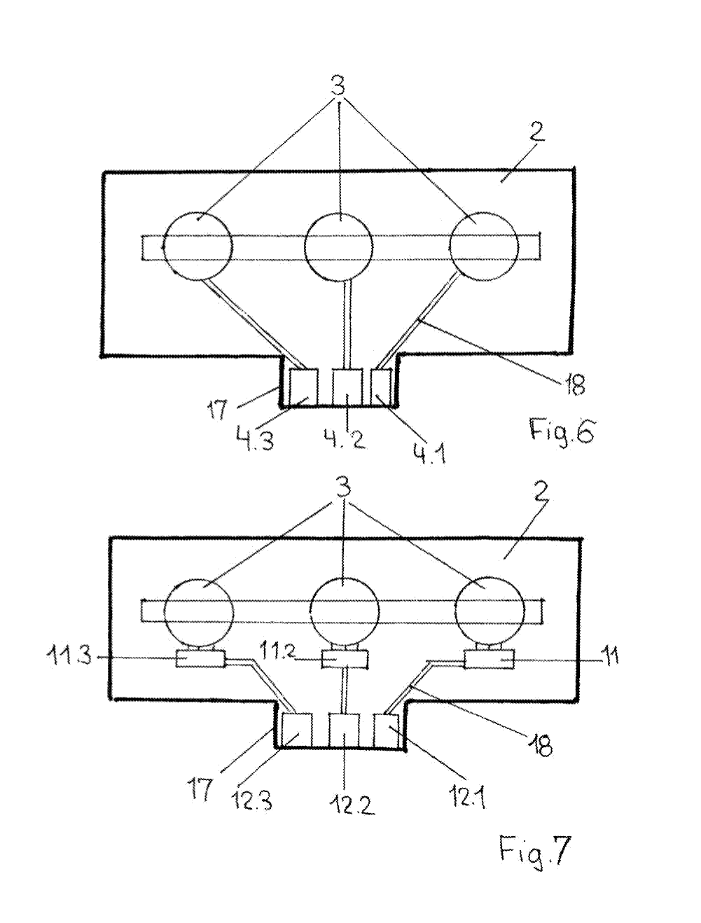

FIG. 6 shows a further form of embodiment with three modular single-phase tap changer components,

FIG. 7 shows a further form of embodiment with three modular separate single-phase selector components as well as load changeover switch components,

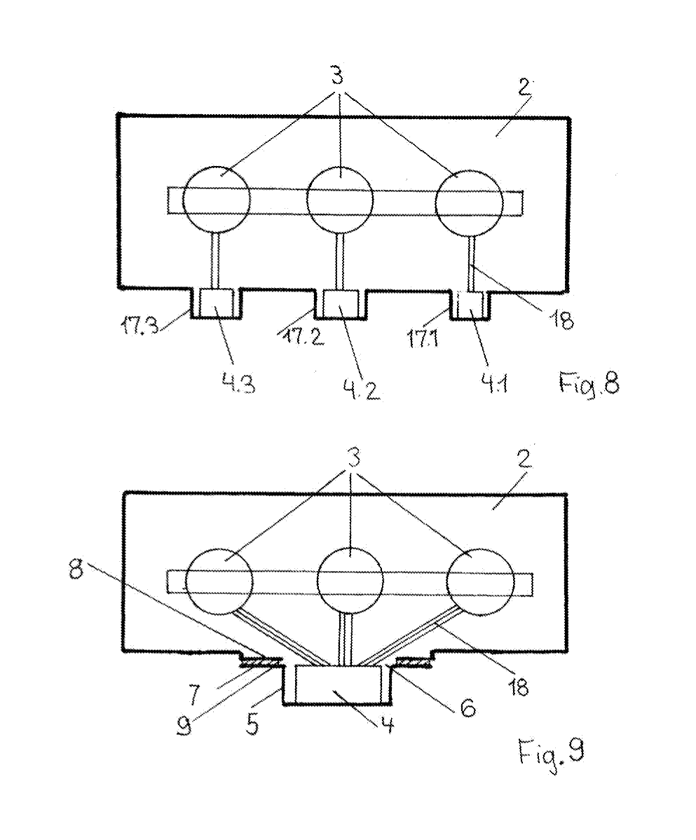

FIG. 8 shows a further form of embodiment with three single-phase tap changers and

FIG. 9 shows a further form of embodiment with a load changeover switch with a housing partly surrounding it.

A regulating transformer 1, that comprises a transformer vessel 2 completely surrounding it and filled with insulating oil, is shown in FIG. 1. The regulating windings 3 for all three phases are located in the transformer vessel 2. Arranged laterally at the transformer 1 is a tap changer 4 that has a housing 5 enclosing it only partly. The housing 5 faces, by its open side, an opening 6 in the transformer vessel 2. The tap changer 4 is thus disposed in connection with the oil volume in the interior of the transformer vessel 2. Here, too, a seal 7 is indeed provided, which outwardly seals the connecting point between a connecting flange 8 of the transformer vessel 2 and a connecting flange 9 of the housing 5 of the tap changer 4, but the common oil volume is not separated, so that—contrary to the prior art—a transformer board is not necessary. Rather, the described seal 7 here serves for sealing the single, entire oil volume to the outside. The electrical connecting lines 10 to the tap changer 4, which for reasons of clarity are not all provided with reference numerals, are additionally also illustrated.

FIG. 2 shows a form of embodiment of a tap changer according to the invention as a built-in changer. Shown here again is a regulating transformer 1 similarly with a transformer vessel 2 that completely surrounds it and receives the oil content. Equally illustrated are regulating windings 3.1, 3.2, 3.3 for the respective phases, which have winding output lines that in turn are electrically connected with the respective tap changer. Arranged directly in the region of the each of these regulating windings 3.1, 3.2, 3.3 is, in accordance with the invention, a tap changer that comprises a respective selector 11.1 . . . 11.3 as well as a respective load changeover switch 12.1 . . . 12.3. It is also possible within the scope of the invention to combine the respective selectors 11.1 . . . 11.3 and the associated load changeover switches 12.1 . . . 12.3 to form a respective combined tap changer according to the load selector principle. A separate motor drive 13, 14, 15 is disposed directly in the transformer vessel 2 directly above each load changeover switch 12.1 . . . 12.3. The drive linkage, which is required in accordance with the prior art with an externally disposed motor drive, in the interior of the transformer vessel to the corresponding tap changers is thus completely eliminated. Also shown here, arranged outside the transformer vessel 2, is a control housing 16 that receives electrical control and indicating means for the respective motor is drives 13 . . . 15. The electrical connecting lines to the motor drives 13 . . . 15 are, for reasons of clarity, not illustrated here. The motor drives 13 . . . 15 are accordingly arranged in the insulating oil; these can be known three-phase synchronous motors, stepping motors, torque motors or other drives.

FIG. 3 shows a further form of embodiment of the invention. The same components are provided with the same reference numerals. In departure from the form of embodiment illustrated in FIG. 2 here a single motor drive 13 is provided in the interior of the transformer vessel 2 and acts by way of linkages 13.1, 13.2, 13.3 on the corresponding load changeover switches 12.1 . . . 12.3 of the tap changers, which are again arranged in the region of the regulating windings 3.1 . . . 3.3.

Not only the form of embodiment shown in FIG. 2, but also that shown in FIG. 3, of a tap changer without an individual housing completely surrounding it has, in common with the transformer vessel 2 enclosing it, a single, common oil volume. A separate oil circuit—as in accordance with the prior art—is thus no longer necessary and separate pipelines, expanders, circuit breaker relays, air dehumidifiers, etc., which are required with known solutions, can be eliminated. Due to the physical proximity between the respective tap changer or the respective single-phase tap changer module and the respective winding, with which it—more specifically the winding output lines thereof—is electrically connected, the conducting equipment, which is required in accordance with the state of the art, through the entire transformer vessel to the outside is eliminated. The tap changers according to the invention are arranged completely in the transformer vessel 2.

The form of embodiment shown in FIG. 2 additionally offers the advantage that through the direct arrangement of modular motor drives at the respective tap changers and thus similarly in the oil-filled transformer vessel the drive linkages required in accordance with the prior art can be eliminated.

A transformer is schematically shown from above in FIG. 4. It comprises a transformer vessel 2 that is filled with insulating oil and in which the regulating windings 3 for all three phases are located. A receiving pocket 17 that receives the tap changer 4 is formed at the transformer vessel. The tap changer 4 is connected with the winding output lines of the regulating windings 3 by way of lines 18, of which for reasons of clarity not all are provided with reference numerals. The tap changer 4, which here comprises the selector 11 as well as the load changeover switch 12, does not have an own housing, so that it is surrounded by the insulating oil in the transformer vessel 2. The receiving pocket 17 can, within the scope of the invention, have any geometric form; it can also be dispensed with entirely in that the tap changer 4 or specific components thereof are fastened directly in the interior of the transformer vessel 2.

A further form of embodiment is shown in FIG. 5, in which the tap changer is resolved, with physical separation, into components; in each instance a single-phase selector 11.1, 11.2, 11.3 is arranged in the region of the respective tap winding 3, whilst the load changeover switch 12—and only this—is arranged in the receiving pocket 17.

FIG. 6 shows a further form of embodiment in which the three single-phase tap changer modules 4.1, 4.2, 4.3 each comprising a selector and a load changeover switch are arranged in the receiving pocket 17.

FIG. 7 shows a further form of embodiment in which three modular separate selectors 11.1, 11.2, 11.3 are arranged in the region of the tap windings 3 and three similarly modular load changeover switches 12.1, 12.2, 12.3 are arranged remotely therefrom in the receiving pocket 17. An advantage of this modular construction is at the outset the module principle that reduces the multiplicity of types and thus lowers costs. For transformer manufacturers there is in addition the substantial advantage of placing the tap changer 4 or the components 4.1, 4.2, 4.3 or 11.1, 11.2, 11.3; 12.1,12.2, 12.3 thereof at locations in or at the transformer vessel 2 favorable for them, which similarly saves costs and constructional volume. It is also possible within the scope of the invention to similarly provide the drive or drives for the tap changer or its components in the oil-filled transformer vessel 2.

FIG. 8 shows a further form of embodiment in which three separate receiving pockets 17.1, 17.2, 17.3, which each receive a respective single-phase tap changer module 4.1, 4.2, 4.3, are provided.

With regard to the general advantages of the invention in these forms of embodiment, which offer a coherent oil volume, the above was already mentioned: a transformer board and special seals are no longer necessary.

Finally, FIG. 9 shows a further form of embodiment in which a tap changer 4 has an own housing 5, which, however, encloses it only partly, i.e. not completely and oil-tightly. This tap changer 4 is connected with a corresponding opening 6 of the transformer vessel 2. In this form of embodiment a seal 7 is indeed required, which outwardly seals off the connecting point between a connecting flange 8 of the transformer vessel 2 and a connecting flange 9 of the housing 5 of the tap changer 4, but in this case as well there is a common oil volume, so that a transformer board is not necessary. Rather, the described seal 7 serves here for sealing the single, entire oil volume to the outside.

1. A tap changer for uninterrupted switching over between winding taps of a tapped transformer, which comprises an oil-filled transformer vessel, wherein the tap changer does not have a housing that is its own or that completely surrounds it and that the tap changer is arranged to be connected with the oil content of the tapped transformer.

2. The tap changer according to claim 1, wherein the tap changer is arranged within the transformer vessel or directly outside at the transformer vessel and respectively in connection with the oil content thereof.

3. The tap changer according to claim 1, wherein it is arranged outside at an opening of the transformer vessel.

4. The tap changer according to claim 1, wherein for reception of the tap changer at least one receiving pocket is at the transformer vessel and connected therewith with respect to the oil content.

5. The tap changer according claim 1, wherein it is arranged in the interior of the transformer vessel in physical proximity to the windings of the tapped transformer.

6. The tap changer according to claim 5, wherein it comprises a plurality of single-phase modules and that each module is arranged in physical proximity to one of the windings.

7. The tap changer according to claim 1, wherein the tap changer has modular resolution into at least one selector and at least one load changeover switch.

8. The tap changer according to claim 7, wherein in each instance the at least one selector is arranged in the region of the tap winding or tap windings.

9. The tap changer according to claim 1, wherein a respective motor drive is so arranged directly at the respective tap changer that a direct mechanical connection of the respective motor drive with the respective tap changer is present.

10. The tap changer according to claim 9, wherein the at least one motor drive for the tap changer or the components thereof is or are similarly arranged in the transformer vessel.
